(19) United States
(12) Patent Application Publication
(10) Pub. No.: US 2005/0076391 A1
(43) Pub. Date: Apr. 7, 2005

(54) Picture displaying apparatus, receiving apparatus and method of presenting commercial message

(76) Inventors: Hiroaki Sugiyama, Kamakura-shi (JP); Atsushi Itsukaichi, Kawasaki-shi (JP); Hiroyuki Ida, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/930,984

(22) Filed: Sep. 1, 2004

(30) Foreign Application Priority Data
Sep. 2, 2003 (JP) 2003-310345

(51) Int. Cl. H04N 7/025; H04N 7/10; H04N 7/16

(52) U.S. Cl. 725/135; 725/32; 725/136; 725/63

(57) ABSTRACT

In a digital broadcast system, when a channel is switched, for instance, on a receiving apparatus side, a digital processing is necessary, accordingly, a time until a next channel becomes viewable, that is, a blackout time is rather longer than ever. By paying attention to this point and inserting a CM during this period, the CM can be assuredly presented to the users. In addition, at the time of selection of one channel including a rise-time of a power source of the receiving apparatus or even at the time of system stoppage, the CM can be similarly presented, and furthermore the finding can be applied also to an ordinary analogue broadcast system. Thereby, picture displaying apparatus and receiving apparatus that can assuredly present commercial messages to users and a method of presenting the commercial messages is provided.

### BACKGROUND OF THE INVENTION

1. Field of the invention

The present invention relates to receiving apparatus for receiving, for instance, satellite digital broadcast and a method of presenting commercial messages (hereinafter, referred to as “CM”) to such apparatus.

2. Description of the Related Art

So far, advertising of companies and the like are performed by broadcasting CMs after one segment of a program by making use of broadcasting network such as TV and radio. (For instance, refer to http://www002.upp.so-net.ne.jp/TVCM_archeology/essay/se ikoshal.html).

However, there is a problem in that when a channel is switched in the middle of a program or immediately before the beginning of a CM after a program, the CM cannot be presented to users as much as the sponsor would expect.

### SUMMARY OF THE INVENTION

In view of above situations, an object of the present invention is to provide picture displaying apparatus and receiving apparatus that can assuredly present a CM to users and a method thereof.

In a digital broadcast system in particular, when a channel is switched, for instance, on receiving apparatus side, digital processing is necessary and a time until a next channel becomes viewable, that is, a blackout time is rather longer than ever. The present inventors paid attention to this point and found that when a CM is inserted during this period, it can be assuredly presented to the users. The inventors further found that a commercial may be presented not only at the time when a channel is switched on the receiving apparatus side but also at the time when one channel including a rise-time of a power source of the receiving apparatus is selected, or at the time when a system is closing down. Furthermore, inventors found out that this can also be applied to an ordinary analogue broadcast system.

Accordingly, a picture displaying apparatus according to a first aspect of the present invention comprises a receiving means for receiving a broadcast wave, a selecting means for selecting a channel to be displayed from the received broadcast wave, a picture displaying means for displaying the picture of the selected channel, a storing means for storing a commercial data for displaying a picture of a commercial message and a control means for controlling the picture displaying means so that the picture of the commercial message based on the stored commercial data is displayed prior to the picture of the channel selected by the channel selecting means.

A receiving terminal according to another aspect of the present invention comprises a receiving means for receiving a broadcast wave, a first selecting means for selecting a first channel to be displayed from the received broadcast wave and an outputting means for outputting a data related to a commercial message prior to outputting a data related to the broadcasted program of the first channel when the first channel is selected.

A method of presenting commercial messages according to still another aspect of the present invention comprising the steps of transmitting broadcast wave containing a data related to the commercial message or storing the data related to the commercial message beforehand in a receiving apparatus for viewing a broadcasted program and outputting the data related to the commercial message prior to outputting a data related to the broadcasted program of the selected channel when the channel is selected in the receiving apparatus.

Here, the data related to the broadcasted program or the data related to the CM include not only data outputted to a display portion and a speaker that the receiving apparatus itself has, but also data outputted to, for instance, an external display portion and the like through an external terminal of the receiving apparatus.

According to the present invention, the data related to the CM can be outputted after a channel is selected by a user and prior to the output of the data related to the broadcasted program, accordingly, the data related to commercial messages can be assuredly presented to the user. As mentioned above, in analogue broadcasting, for instance, when a channel is selected, data related to the broadcasted program are instantaneously outputted. However, in digital broadcasting, after a channel is selected, data related to the broadcasted program are not immediately outputted but requires a several seconds before being outputted. This is because in the digital broadcasting, since signal processing after the receipt of the broadcast wave until the output thereof is complicated, a time required for processing the data is longer. According to the present invention, the data related to commercial messages can be outputted making use of the time that the data of the broadcasted program is being processed so that the data can be assuredly presented to the users.

According to one embodiment of the present invention, when a data related to the broadcasted program of the first channel is switched to a second channel by the first selecting means, the outputting means outputs data related to the commercial message prior to the data related to the broadcasted program of the second channel.

According to the present invention, when a channel is switched, the data related to commercial messages can be outputted making use of the time that the data of the broadcasted program is being processed so that the data related to the commercial messages can be assuredly presented to the users even at the time when the users and the like, for instance, switch to another channel in the middle of the broadcasted program without viewing the CM.

According to one embodiment of the present invention, the first selecting means select the first channel from the broadcast wave received by the receiving means when a power source of the receiving apparatus is turned on and the outputting means outputs the data related to the commercial message prior to the data related to the broadcasted program of the first channel.

For instance, in digital broadcasting, broadcast wave is received when a power source of the receiving apparatus 4 is turned on in a first place. Accordingly, several seconds are also required for processing data after the power source is turned on until the broadcasted program is outputted to a display portion. According to the present invention, the data related to the commercial messages can be outputted making use of the time that the data of the broadcasted program is being processed when the power source is turned on. The present invention can be positively made use of in an analogue broadcast system.

According to still another embodiment of the present invention, the outputting means outputs the data related to the commercial message in a first time period; the first time period being the time period beginning from the first channel is selected until the data related to the broadcasted program corresponding to the selected channel becomes capable of being displayed on the displaying portion.

For instance, in the digital broadcasting, during the first time period, there is a state where there is no output, i.e. a blackout state where nothing is displayed on the display portion. According to the present invention, data related to the commercial messages can be displayed on a display portion which otherwise in the blackout state, making use of the first time period.

According to another embodiment of the present invention, the outputting means outputs the data related to the commercial message prior to outputting the data related to the broadcasted program when a second time period is longer than the first time period; the second time period being a time period which the data related to the commercial message is outputted.

According to such configuration, since the data related to the commercial messages are outputted with higher priority than the data related to the broadcasted program, the data related to the commercial messages are not stopped in the middle of outputting process.

According to still another embodiment of the present invention, the outputting means outputs the data related to the commercial message so that the picture displayed based on the data fades out to disappear when the second time period is longer than the first time period.

According to such configuration, visual interest of the users can be aroused owing to fading out of a picture, and while securing the first time period as a period for outputting the data related to the commercial messages, the data related to the commercial messages can be outputted with residual image of fading out remaining.

According to another embodiment, the present invention comprises a first extracting means for extracting the data related to the commercial message contained in a controlling channel; the controlling channel being a channel contained in a broadcast wave for controlling the broadcast of the first channel and the second channel and a first storing means for storing the data related to the commercial message extracted by the first extracting means.

Thereby, the data related to the commercial messages can be transmitted irrespective of a broadcasting channel for transmitting program data.

According to still another embodiment, the present invention comprises a second extracting means for extracting the data related to the commercial message contained in the data related to the broadcasted program and a second storing means for storing the data related to the commercial message extracted by the second extracting means.

Thereby, the data related to the commercial messages can be transmitted correlated with the data related to the broadcasted program. Accordingly, commercial messages corresponding to a program can be presented without particularly correlating the program data with the data related to the commercial messages.

According to another embodiment, the present invention comprises a storing means for storing the data related to the commercial messages beforehand.

With this configuration, as the data related to the commercial messages being stored beforehand, the invention can be reduced to practice without delivering the data related to the commercial messages between, for instance, the broadcast system and the receiving apparatus. In particular, the invention is effective in a case where the commercial messages are presented at the time when the power source of the receiving apparatus is turned on. Storing data related to the commercial messages includes not only a case where data related to the commercial messages are stored at the time of selling of the receiving apparatus, but also includes a case where data related to the commercial messages being stored when a power source of the receiving apparatus is turned off and the like.

According to still other embodiment, the present invention comprises a position detecting means for receiving a GPS signal transmitted from a GPS satellite go around the earth and detecting a position of the receiving apparatus based on the received GPS signal and a second selecting means for selecting the data related to the commercial message according to the position detected by the position detecting means.

According to such configuration, data related to the commercial messages corresponding to a position where the receiving apparatus is used are selected and outputted, and, accordingly, the data related to the commercial messages can be effectively presented to the users. For instance, depending on the case where the receiving apparatus is used in Tokyo or in Hokkaido, the commercial messages in accordance with the respective regions can be presented. Furthermore, in the case of the receiving apparatus being used in the neighborhood of a hamburger shop for instance, commercial messages related to hamburgers can be presented in very timely manner.

According to another embodiment of the present invention, the outputting portion output a different version of the data related to the commercial message according to the number of times that the data related to the commercial message being outputted.

With this configuration, since data of different versions are presented, data related to the commercial messages can be effectively presented without making users feel tired.

According to still another embodiment of the present invention, when a data related to the broadcasted program of the first channel is switched to the second channel by the first selecting means, the outputting means outputs data related to the commercial message which is to be broadcasted in the broadcasted program of the first channel prior to outputting the data related to the broadcasted program of the second channel.

With such configuration, even when a user switches a channel to another channel without viewing the commercial message, data related to the commercial message that are to be outputted in a broadcasted program of the previous channel before the switching is outputted, accordingly, data related to the commercial messages can be assuredly presented to the user.

According to another embodiment of the present invention, each of the data related to the commercial message stored in the storing means has a predetermined priority order and the receiving apparatus further comprises an erasing means for erasing one of the plurality of data related to the commercial message stored in the storing means according to the priority order when the third storing means becomes full with data stored.

According to such configuration, for instance, by prioritizing data related to the commercial message of sponsors who pay expensive advertising rates with high priority, the commercial message of such sponsor can secure longer hours of exposure.

According to still another embodiment, each of the data related to the commercial message stored in the third storing means is designated with a date on which the data is to be erased and the erasing means erases the data related to the commercial message according to the designated date.

According to such configuration, data stored in the storing means are erased when the predetermined period lapses, therefore, the storing means can be avoided from becoming full. Furthermore, depending on the amounts of advertising rates, periods that the commercial message being exposed can be set longer or shorter.

According to another embodiment of the present invention, the data related to the commercial message is designated with the number of times that the commercial message is to be outputted and the outputting means outputs the data related to the commercial message with the designated erasing day thereof is approaching and with the designated number of times to be outputted is small in higher priority order.

According to such configuration, data related to the commercial messages can be assuredly presented to the users for a predetermined number of times before the predetermined date of when the commercial message to be erased.

A receiving apparatus according to another aspect of the present invention comprises a receiving means for receiving a broadcast wave, a broadcasted program data outputting means for outputting the data related to the broadcasted program received through the broadcast wave and a commercial message data outputting means for outputting a data related to the commercial message when the data related to the broadcasted program is ceased to be outputted.

According to a method of presenting commercial messages of still another aspect of the present invention, transmitting broadcast wave contains a data related to the commercial message or storing the data related to the commercial message beforehand in a receiving apparatus for viewing a broadcasted program and outputting the data related to the commercial message when the receiving apparatus is incapable of outputting a data related to the broadcasted program of a channel selected in the receiving apparatus.

When data outputting means discontinues outputting program data including, for instance, a case where a power source of the receiving apparatus is disconnected, broadcast wave is stopped to transmit, or a blackout owing to switching of a channel in the case of the digital broadcasting. According to the present invention, making use of such time, data related to commercial message can be outputted from a commercial data outputting means.

According to one embodiment of the present invention, when a command to turn off a power source of the receiving apparatus is inputted, the commercial message data outputting means outputs the data related to the commercial message after the output of the data related to the broadcasted program is finished and prior to the turning off of the power source.

According to such configuration, for instance, data related to the commercial messages can be outputted making use of a period beginning from the user inputting a signal to disconnect the power source of the apparatus until the apparatus is shut down completely.

According to another embodiment of the present invention, the commercial data outputting means outputs the data related to the commercial message when the data related to the broadcasted program is ceased to be outputted from the broadcasted program outputting means caused by the broadcast wave being ceased to be transmitted.

For instance, in the digital broadcasting, when broadcast wave is ceased to transmit, the receiving apparatus has to receive broadcast wave once more to output again. Accordingly, a predetermined time period is required from the reception of the broadcast wave to outputting the received data. However, in the present invention, data related to the commercial messages are outputted making use of the processing time, therefore, commercial data can be assuredly presented to users.

Accordingly, according to the invention, data related to commercial messages can be assuredly presented to the users.

These objects and other objects and benefits of the present invention can be easily confirmed with reference to explanations and attached drawings below.

### BRIEF DESCRIPTION OF THE DRAWINGS

FIG. 1 is a schematic diagram showing a configuration of a satellite broadcast system according to one embodiment of the present invention.

FIG. 2 is a block diagram showing a configuration of a broadcasting station shown in FIG. 1.

FIG. 3 is a block diagram showing a configuration of a receiving terminal shown in FIG. 2.

FIG. 4 is a flowchart showing operations of a receiving terminal shown in FIG. 3.

FIG. 5 is a diagram (part-1) of appearance (display) of a receiving terminal shown in FIG. 3.

FIG. 6 is a diagram (part-2) of appearance (display) of a receiving terminal shown in FIG. 3.

FIG. 7 is a diagram (part-3) of appearance (display) of a receiving terminal shown in FIG. 3.

FIG. 8 is a flowchart showing operations of a receiving terminal according to another embodiment.

FIG. 9 is a flowchart showing operations of a receiving terminal according to still another embodiment.

FIG. 10 is a flowchart showing operations of a receiving terminal according to another embodiment.

FIG. 11 is a flowchart showing operations of a receiving terminal according to still another embodiment.

FIG. 12 is a diagram showing a channel configuration of a digital broadcast wave according to one embodiment of the invention.

FIG. 13 is a diagram showing a configuration of a control channel according to one embodiment of the invention.

FIG. 14 is a diagram showing a configuration of a broadcast channel according to one embodiment of the invention.

FIG. 15 is a block diagram showing a configuration of a receiving terminal according to still another embodiment.

FIG. 16 is a flowchart showing operations of a receiving terminal according to another embodiment.

FIG. 17 is a diagram (part-1) showing appearance (display) of a receiving terminal according to another embodiment.

FIG. 18 is a diagram (part-2) showing appearance (display) of a receiving terminal according to another embodiment.

FIG. 19 is a diagram (part-3) showing appearance (display) of a receiving terminal according to another embodiment.

FIG. 20 is a flowchart showing operations of a receiving terminal according to another embodiment.

### DETAILED DESCRIPTION OF THE PREFERRED EMBODIMENTS

Hereafter, embodiments of the present invention will be explained with reference to the drawings.

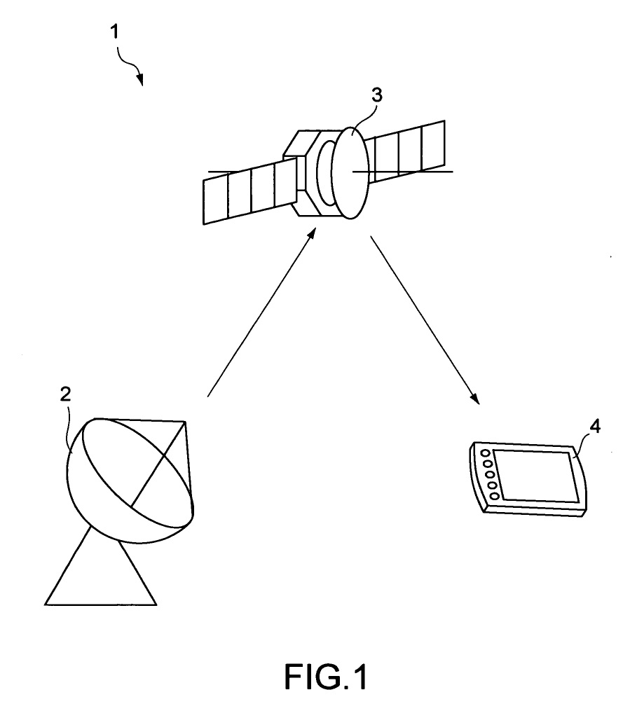

FIG. 1 is a diagram schematically showing a configuration of a satellite broadcast system according to one embodiment of the invention.

As shown in FIG. 1, satellite broadcast system 1 includes broadcasting station 2, and broadcast satellite 3 that receives program data and so on through an uplink from broadcasting station 2 and transmits the program data and so on through digital satellite broadcast wave towards the earth.

A user on the earth receives the digital satellite broadcast wave transmitted from broadcast satellite 3 with receiving terminal 4 and watches pictures and listens to audios.

In the digital broadcast wave, through a plurality of channels, for instance, 63 channels at maximum, a plurality of program data is simultaneously transmitted, and a user can see and hear a desired program by selecting a desired channel with the receiving terminal 4. For instance, in the broadcast system, a microwave (S-band) of 2.6 GHz is used. In a transmission system in the satellite broadcast system 1, a CDM (Code Division Multiplexing) system that can realize excellent reception even under a multi-path environment is preferably used. However, other systems may also be used.

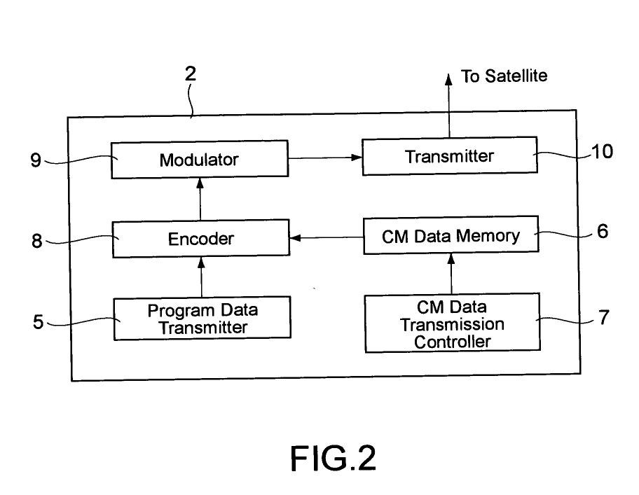

FIG. 2 is a diagram schematically showing a configuration of the broadcasting station 2.

As shown in FIG. 2, broadcasting station 2 includes a program data transmitter 5 for storing program data that includes picture data and controlling data of programs to be broadcasted and transmits the stored program data; a CM data memory 6 for storing CM data that includes picture data and controlling data of CMs to be broadcasted; a CM data transmission controller 7 that controls a timing when the CM data are transmitted; a encoder 8 for encoding the program data and the CM data into a format such as MPEG4 to compress; a modulator 9 for modulating the program data and the CM data; and a transmitter 10 for transmitting these data towards the broadcast satellite 3. The program data transmitter 5 stores program data taken with, for instance, a TV camera and the like and the CM data memory 6 stores similarly taken CM data.

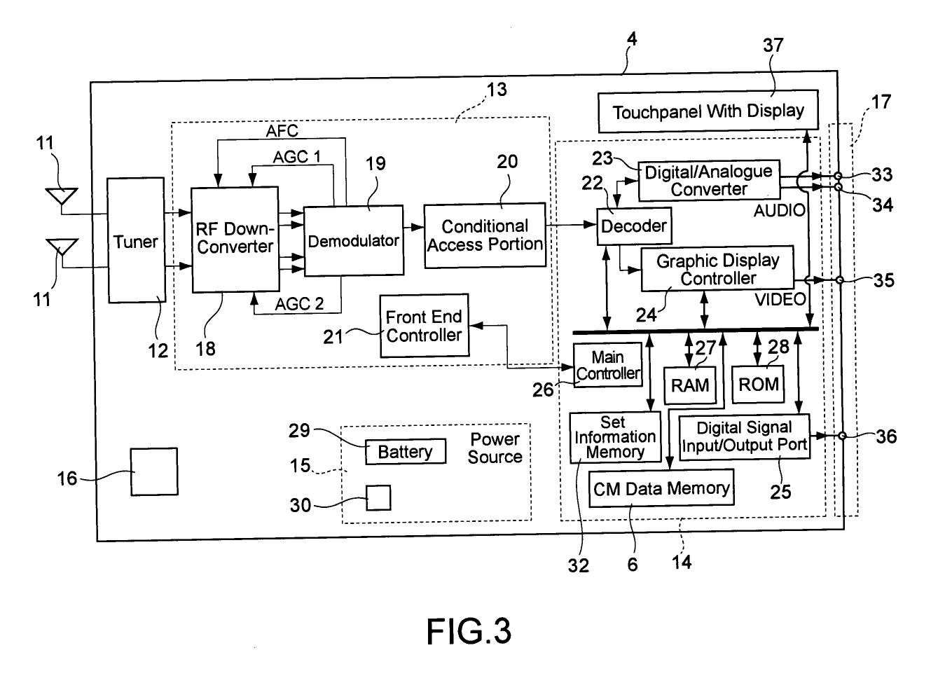

FIG. 3 is a diagram schematically showing a configuration of the receiving terminal 4.

As shown in FIG. 3, receiving terminal 4, in its main portion, includes a pair of built-in antennas 11 that receives according to diversity; tuner 12 for tuning the received broadcast wave; front end portion 13; backend portion 14; power supply 15; channel selector 16 for selecting a channel; and output portion 17.

Front end portion 13 includes RF down converter 18 for delivering to a demodulator with an RF signal received by the built-in antenna 11 upon down-converting the signal inputted upon being tuned by the tuner 12; demodulator 19 for demodulating the RF signal; conditional access portion 20 that, in pay-TV that sets condition on the access or reception thereof, that controls decoding of the RF signal according to the presence of subscription; and front end controller 21 that controls the whole of the front end portion 13.

Back end portion 14 includes decoder 22 that decodes a signal demodulated by front end portion 13; digital analogue converter 23 (hereinafter, referred to as DAC 23) that converts the decoded digital signal to an analogue audio signal; graphic display controller 24 (hereinafter, referred to as GDC 24) that converts a decoded digital signal to, for instance, an NTSC picture signal; digital signal input/output portion 25 to which a controlling signal is inputted from and outputted to outside the system; main controller 26 that integrally controls the whole system; RAM 27 and ROM 28; furthermore CM data memory 6 that stores the CM data decoded by the decoder; and setting information memory portion 32 that stores information related to settings and the like of the receiving terminal 4. The setting information memory portion 32 is configured so as to hold memory even when a power source of the receiving terminal 4 is turned off.

The power source 15 includes battery 29 for supplying electric power to the respective portions and power source switch 30 that switches on/off of the power source of the receiving terminal 4. Power source switch 30 is formed of, for instance, a button and the like, and on and off of the power is operated by a user pushing down or releasing the button.

The channel selector 16 is formed of, for instance, a button or the like, and the channel can be selected as the user pushes down the button. Information of the selected channel is stored in the setting information memory portion 32.

The output port 17 includes audio signal output ports 33 and 34 that output an audio signal converted by the DAC 23; picture signal output port 35 that outputs a picture signal converted by the GDC 24; controlling signal output port 36 that outputs a control signal from digital signal input/output portion 25; and touch-panel type display 37. The audio signal, the picture signal and the controlling signal are outputted through the respective output ports, for instance, to a display and so on of, for instance, a car navigation system.

In the next place, operations of thus configured satellite broadcast system will be explained.

First, in the broadcasting station 2, prepared program data and prepared CM data are stored in the program data transmitter 5 and the CM data memory 6 respectively. The program data and the CM data are converted in encoder 8 into, for instance, an MPEG4 format to compress, followed by modulating by the modulator 9, and transmitted toward the broadcast satellite 3 by the transmitter 10. The broadcast satellite 3 receives data transmitted in a plurality of channels and transmits as digital satellite broadcast wave towards the earth. The data include, for instance, the program data and the CM data.

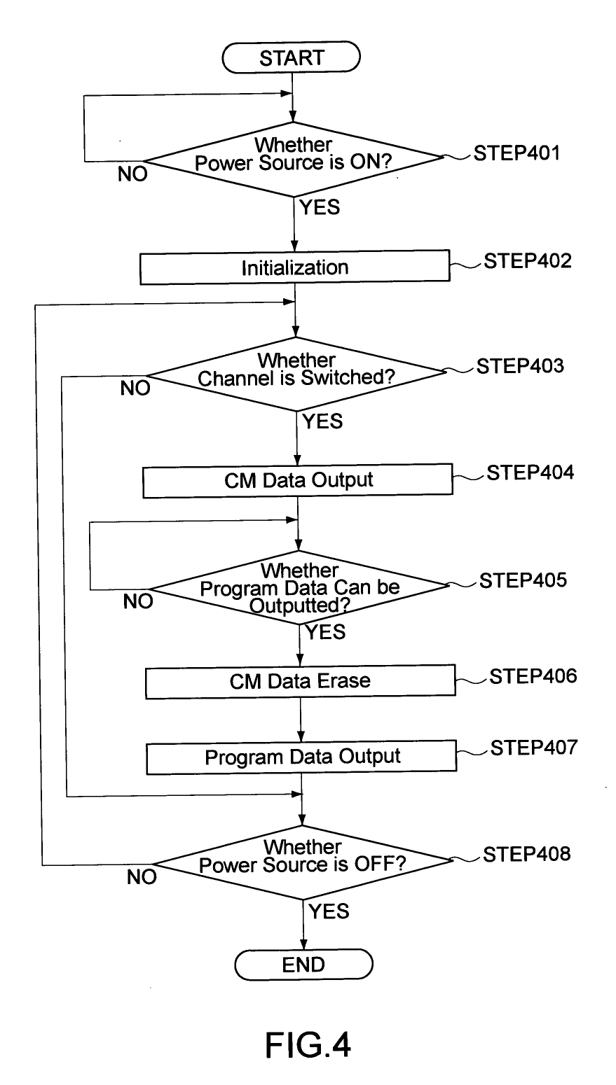

Next, operations of the receiving terminal 4 will be explained based on FIG. 4.

First, the main controller 26 judges whether the power source is turned on (step 401). For instance, when the power source switch 30 is turned off, a signal conveying message that the power source 30 being off is transmitted from the power source 15 to the main controller 26. In this place, the main controller 26 judges that a power source of the receiving terminal 4 is not turned on and the judgment process of step 401 is repeated. Here, when, for instance, the user pushes down the power source switch 30 and a signal conveying message that the power source switch 30 is on is transmitted from the power source 15 to the main controller 26. Upon receiving the signal to the effect that the power source switch 30 is turned on, the main controller 26 judges that the power source of receiving the terminal 4 is turned on and proceeds to the next step. It goes without saying that an on/off operation of the power source may be performed comprehensively.

In the next place, the main controller 26 controls the receiving terminal 4 so that the receiving terminal 4 is initialized (step 402).

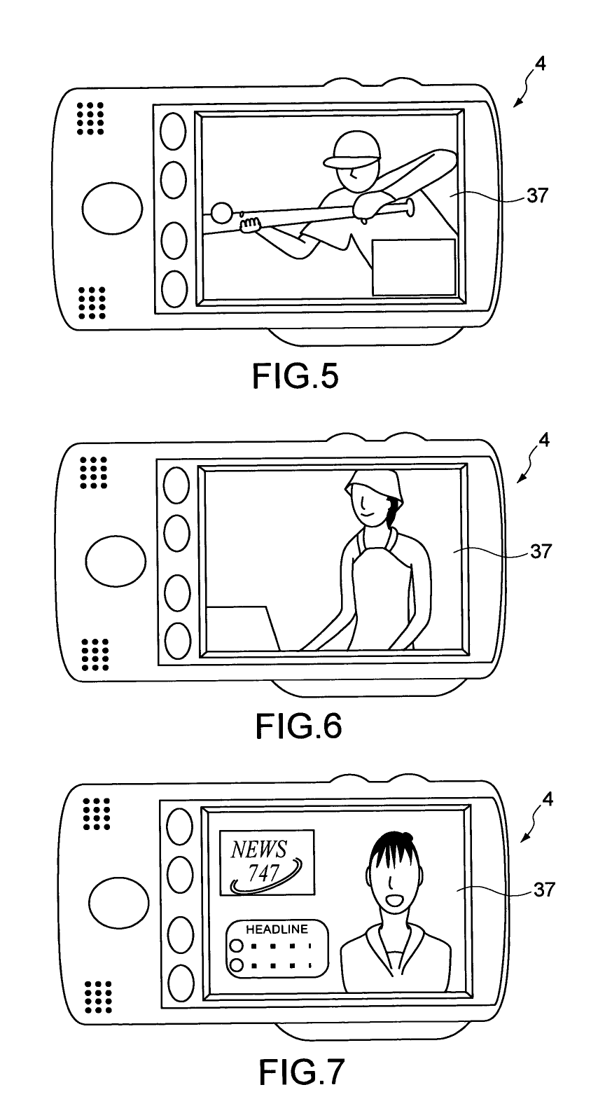

As to controlling of the initialization, first, the main controller 26 accesses the set information memory port 32 to read set information on the channel and the like that had been displayed at the time when the power source was turned off last time, or controls the tuner 12 so that the tuned channel becomes the one selected from a plurality of channels superposed according to, for instance, a CDM (Code Division Multiplex) format, and thereby reproduces stored set states. Then, the main controller 26 accesses the tuner 12, the decoder 22 and the CM data memory 6 to have the decoded CM data stored in the CM data memory 31. On the other hand, the main controller 26 accesses the DAC 23 and the GDC 24, the audio signal output ports 33 and 34, and the picture signal output port 35, and outputs the program data converted into an output signal. When the initialization of the receiving terminal 4 is thus performed, a picture such as shown in FIG. 5 is displayed on the display 37.

Subsequently, from this state, the main controller 26 judges whether the present channel is switched to another channel or not (step 403). When the main controller 26 receives a signal from the channel switch portion 16 to the effect that, for instance, the channel is switched, the main controller 26 judges that the channel is switched and proceeds to the next step.

In the next place, the main controller 26 controls so that one CM data is selected at random, for instance, from the CM data stored in the CM data memory 6 and the data is outputted (step 404). With this step, as shown in FIG. 6, the CM data are outputted and a picture based on the CM data is displayed on the display 37.

Subsequently, the main controller 26 judges whether a preparation for outputting the program data has come to a completion or not (step 405). The main controller 26 judges that the preparation came to the completion when, for instance, the program data are converted into the output signal for displaying a picture.

Then, the main controller 26 erases the CM data from the memory (step 406) and controls the DAC 23 and the GDC 24 to output the program data (step 407). As a result of the control, a picture based on the program data is displayed on the display 37, as shown in FIG. 7.

In the next place, when the channel cannot be switched in the step 403, or when the program data are outputted according to the step 406, the main controller 26 judges whether the power source is turned off or not (step 408).

Upon judging that a power source is turned off, the main controller 26 controls so that the operations of the respective devices may be stopped. Due to the control, operations of the receiving terminal 4 come to a completion. When the power source is judged being turned off, the set information such as the selected channel and the like are stored in the setting information memory portion 32. When the power source is judged being not turned off, steps from the step 403 are repeated.

According to the embodiment, by making use of a time period necessary for a signal to be processed, that is, a time period beginning from a user selecting a channel until the program data are ready to be outputted, a CM data can be outputted; accordingly, the CM can assuredly be presented to the user.

The present invention is not restricted to the embodiments explained above, but allows various modifications.

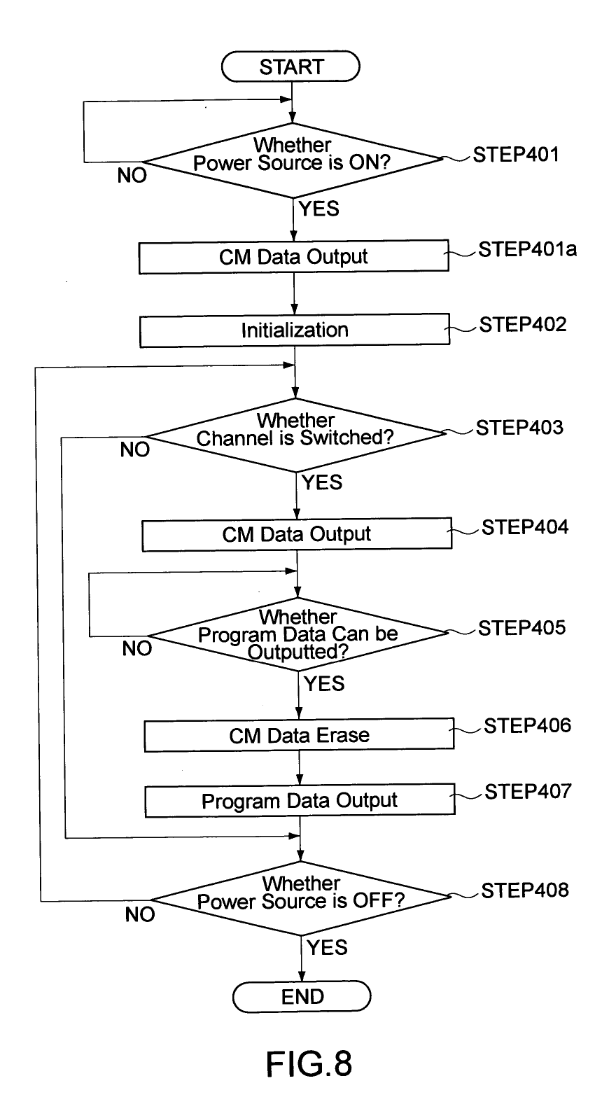

For instance, as shown in step 401a in FIG. 8, it is possible to have the main controller 26 control the receiving terminal, so that the CM is data is outputted, for instance, for a time period beginning from the power source 30 being turned on until the program data being outputted, and thereby to display a picture based on this on a screen of display 37.

When the power source switch 30 is turned on, the main controller 26, can control the receiving terminal 4 so that the CM data previously stored in the CM data memory 31 are outputted while performing the initialization process. Thereby, the CM data can be outputted by making use of the time required for initialization after the power source switch 30 of the receiving terminal 4 is turned on. Accordingly, a picture formed based on the CM data can be assuredly presented to a user.

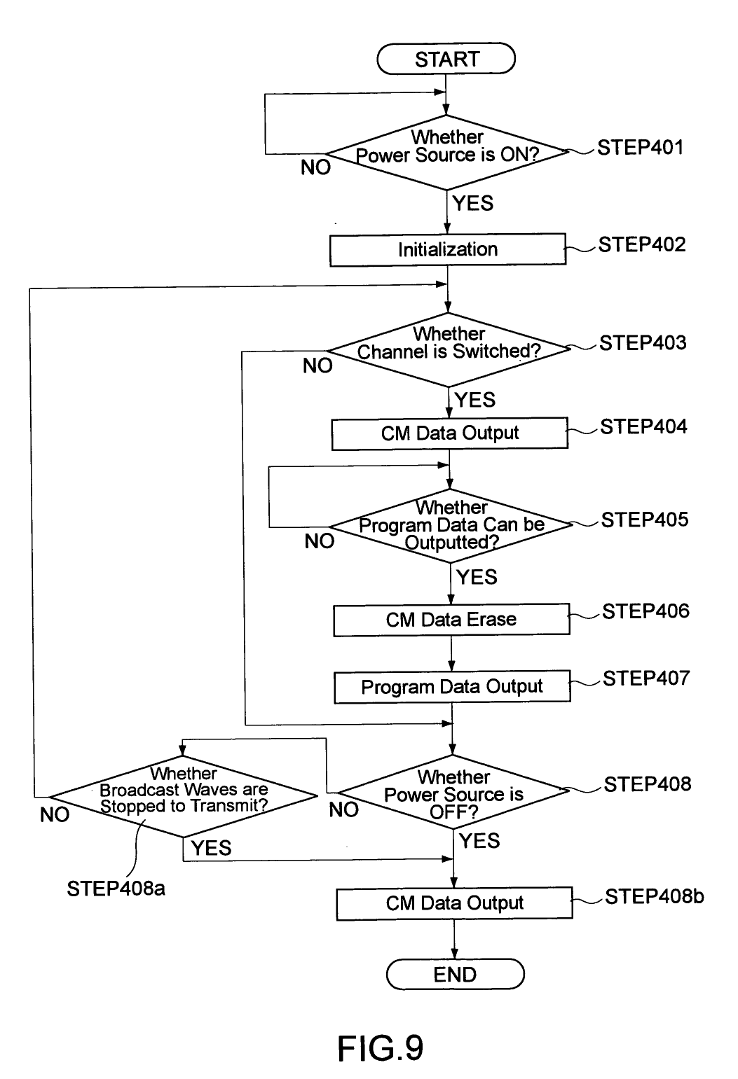

Furthermore, as shown in FIG. 9, the CM data can be outputted (step 408b) in a case where the power source switch 30 of the receiving terminal 4 being turned off (step 408), or in a case where the broadcast wave being ceased to be transmitted (step 408a). Thereby, the CM can be naturally and assuredly presented to the users without putting them off.

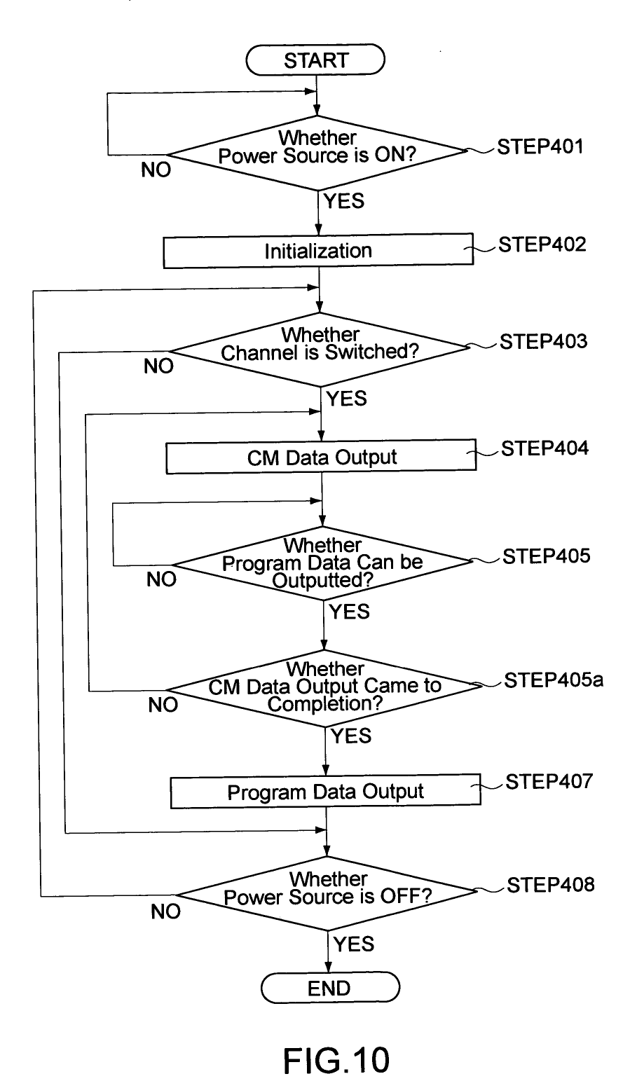

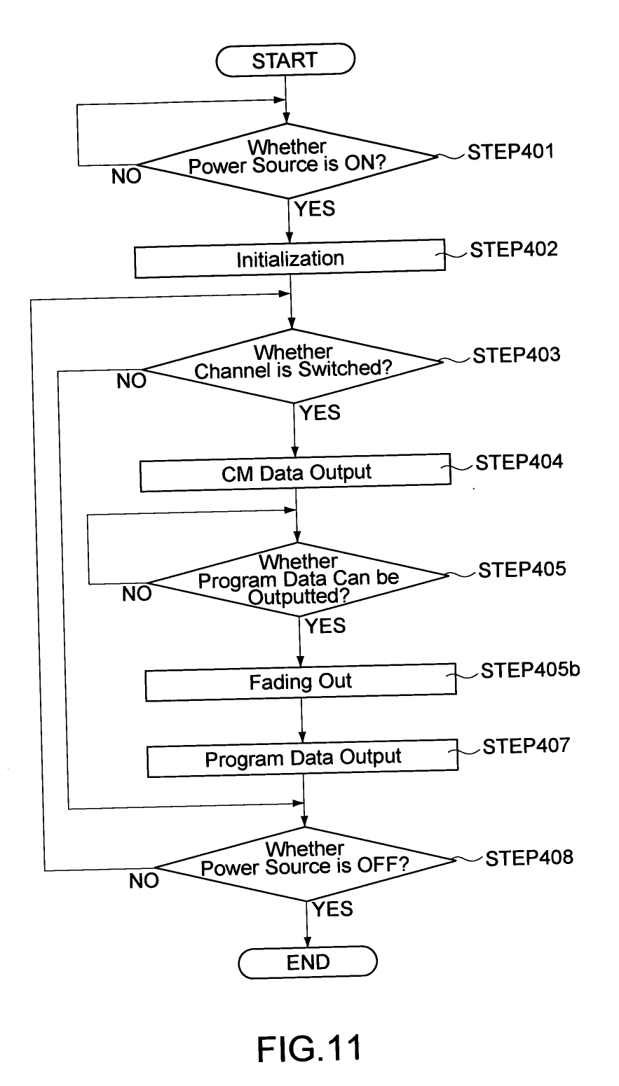

Still furthermore, in the case of the CM data being displayed due to, for instance, switching of the channel and soon, in some cases, an output preparation of the program data comes to a completion before an output of the CM data comes to a completion; however, in this case, as shown in the step 405a of FIG. 10, the program data may be outputted after the completion of the output of the CM data; in other words, the CM data may be outputted prior to the program data. Furthermore, in this case, as shown in the step 405b of FIG. 11, a picture formed based on the CM data may be erased in a fading out way.

In the next place, a method by which the CM data are transmitted from the satellite broadcast system 1 to the receiving terminal 4 of the present invention will be explained.

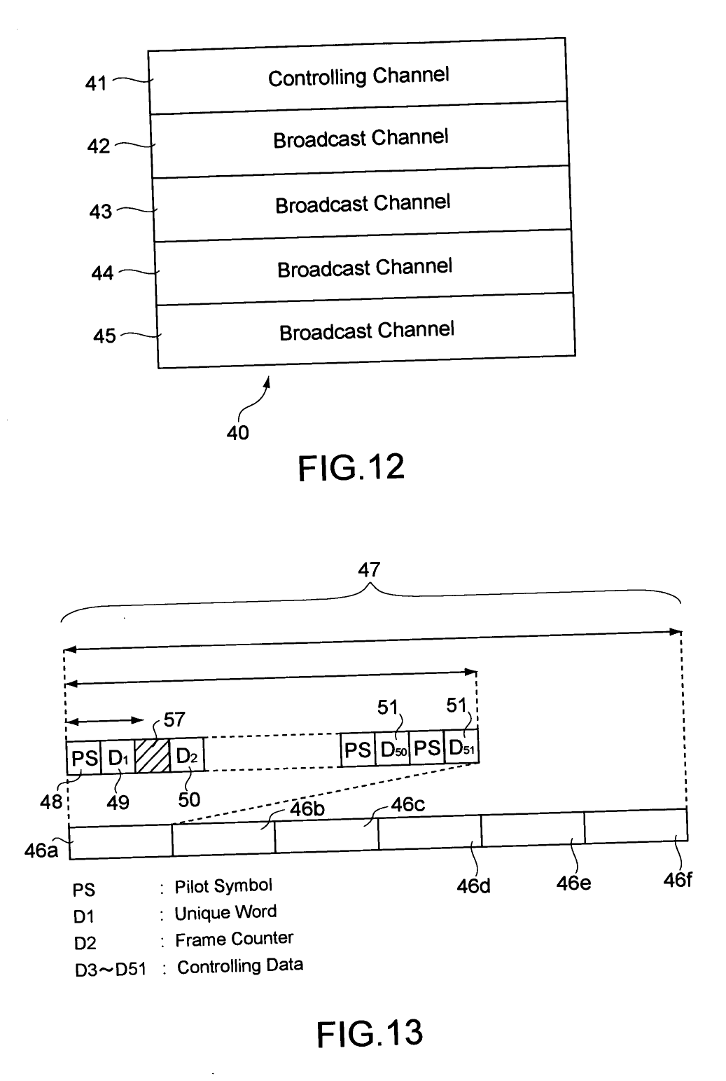

Here, as shown in FIG. 12, digital satellite broadcast wave 40 include, for instance, one controlling channel 41 and a plurality, for instance, four of broadcast channels 42, 43, 44 and 45. The controlling channel 41 includes control information and the like of the broadcast channels. The broadcast channels 42, 43, 44 and 45 include program data, CM data and the like. Information such as system information related to the satellite broadcast system 1 is also included. The control channel 41 is comprised as super frame 47, as shown in FIG. 13, which is a combination of, for instance, six groups of frames, and a controlling data of the channels and the like are incorporated into the frame of 46a, 46b, 46d, 46d, 46e and 46f. The frame 46 includes pilot symbol 48 that is inserted for data restoration at a predetermined interval; unique word 49 shows a starting point of the data for each frame; frame counter 50 distinguishes the frame; and controlling data 51. In such data, when there is a vacant region between, for instance, the unique word 49 and the frame counter 50, the CM data 57 can be inserted into such region.

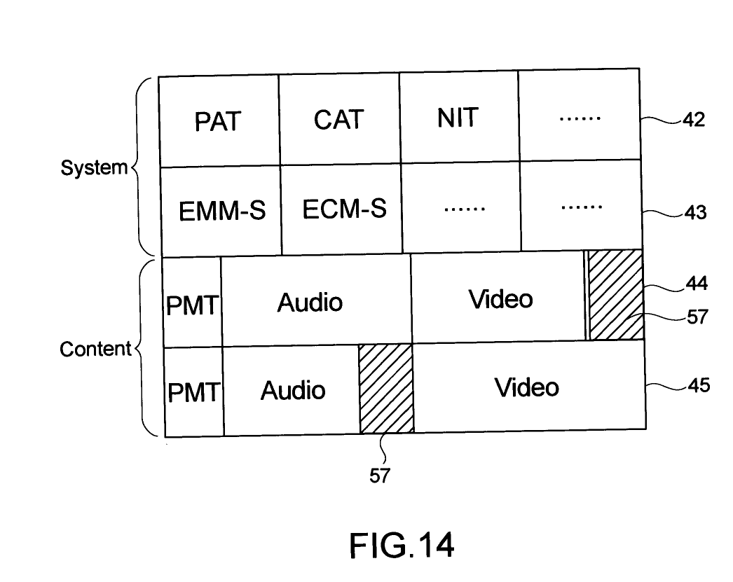

Furthermore, as shown in FIG. 14, a broadcast channel may be divided into four, and the system information and so on related to the satellite broadcast system 1 may be contained in the broadcast channels 42 and 43, and the data related to the broadcasted programs and the CMs may be contained in the remaining broadcast channels 44 and 45. In the broadcast channels 42 and 43, information mainly related to the system such as PAT (Program Association Table), CAT (Conditional Access Table), NIT (Network Information Table), EMM-S (Entitlement Control Message for S-band) and ECM-S (Entitlement Management Message for S-band) is contained; and in the broadcast channels 44 and 45, information mainly relating to broadcast such as PMT (program Map Table), audio information and video information is contained. Among these, when, for instance, a region of the video information of the broadcast channel 44 is vacant, the CM data can be inserted into the vacant region.

In the above embodiment, when the CM data are incorporated, attribute information such as preference of a user, viewing time zones and a family structure may be incorporated together. For instance, a case where a user has an interest in automobiles will be explained. Attribute information that the user has an interest in automobiles is set by use of the user interface of the terminal on the system side or the user interface of the terminal of the user side through the internet and the like. The attribute information is stored in the setting information memory portion 32 and the like, when, for instance, the digital broadcast wave is received. When the CM data are displayed upon switching of the channel or the like, the main controller 26 controls the output of the CM data and so on so that the CM data close to the attribute information from the information stored in the setting information memory portion 32 is read based on the attribute information, for instance, CM data relating to the automobiles may be selected and read from the CM data memory 31 and being outputted. By thus carrying out, CM data fitted to preference of the user can be outputted and displayed on a screen of, for instance, the display 37 attracting more attention of the user.

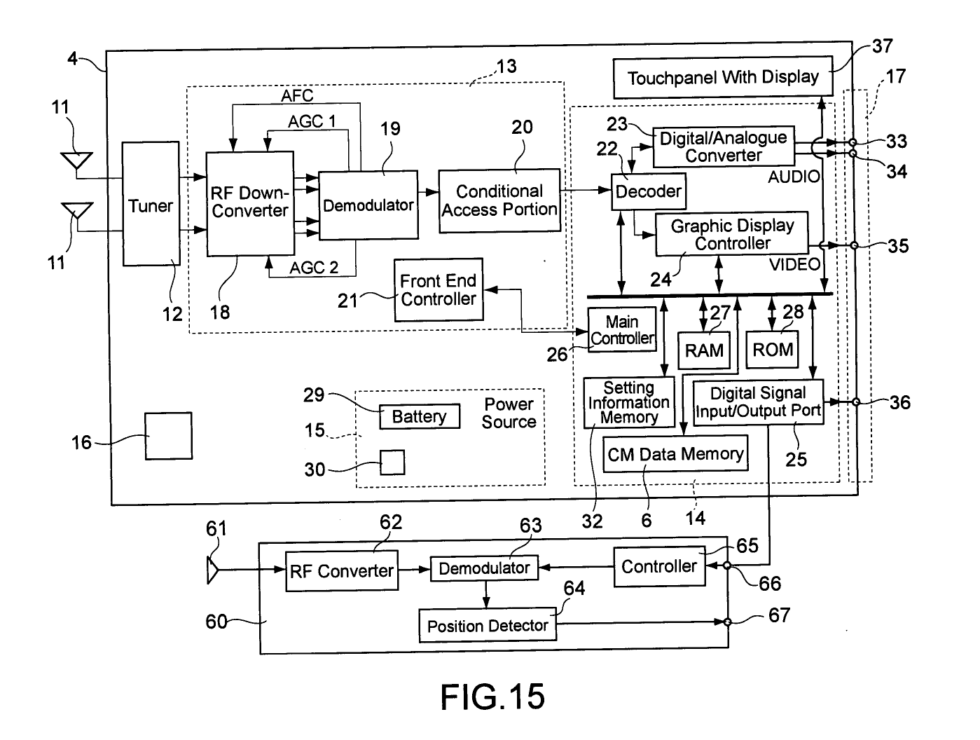

Furthermore, as shown in FIG. 15, a specific CM may be presented in accordance with the position of the receiving terminal 4 measured by the GPS receiver 60 attached thereto which enables the position of the receiving terminal 4 to be measured.

Here, the GPS receiver 60 includes RF down-converter 62 that converts an electric wave signal (GPS signal) received through GPS receiving antenna 61 into an RF signal; demodulator 63 that captures a GPS signal from a converted RF signal and demodulates the captured GPS signal by use of a PN code; and position detector 64 that detects a position based on the demodulated GPS signal. The controller 65 provides a timing signal for capturing the GPS signal to the demodulator 63. From the output terminal 67, a result of position detection is outputted. The result of the position detection is transmitted through the digital signal input/output portion 25 to the main controller 26. Accordingly, when the digital signal input/output port 25 and the input terminal 66 of the GPS receiver 60 are connected through the cable 68, the position information measured by the GPS receiver 60 can be presented to the receiving terminal 4. Information of kind and nature of the CM data corresponding to the position is stored in, for instance, the setting information memory portion 32 beforehand.

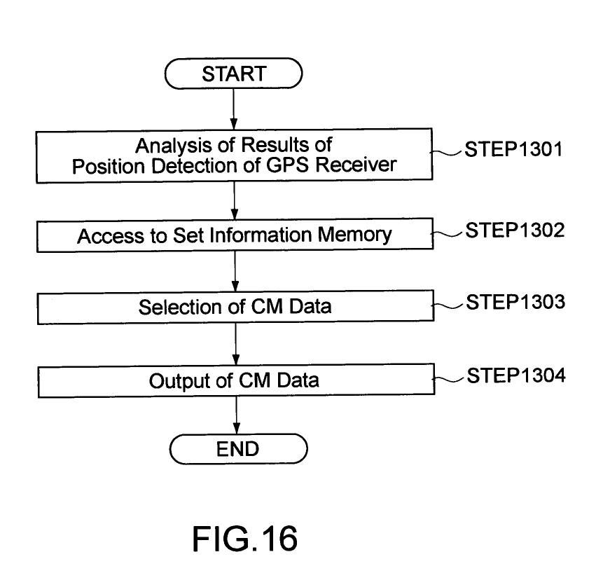

Then, as shown in FIG. 16, for instance, in a case where the CM data is being displayed upon switching of the channel, first, the main controller 26 analyzes the results measured by the GPS receiver 60 and detects the position of the receiver terminal 4 (step 1301). In the next place, the main controller 26 accesses the setting information memory portion 32 to read information of kind and nature of the CM data corresponding to the detected position (step 1302), followed by selecting CM data in accordance with the information from the CM data memory 31 (step 1303), and outputting the selected CM data (step 1304).

For instance, when a user comes close to a restaurant at dinnertime, CM data of the restaurant may be made to display. With this configuration, data related to the commercial messages in accordance with a preference of a user using the receiving terminal 4 or the attribute information such as a position where the receiving terminal 4 is used and can be selected and outputted.

Furthermore, CM data may be presented with a version thereof is successively increasing.

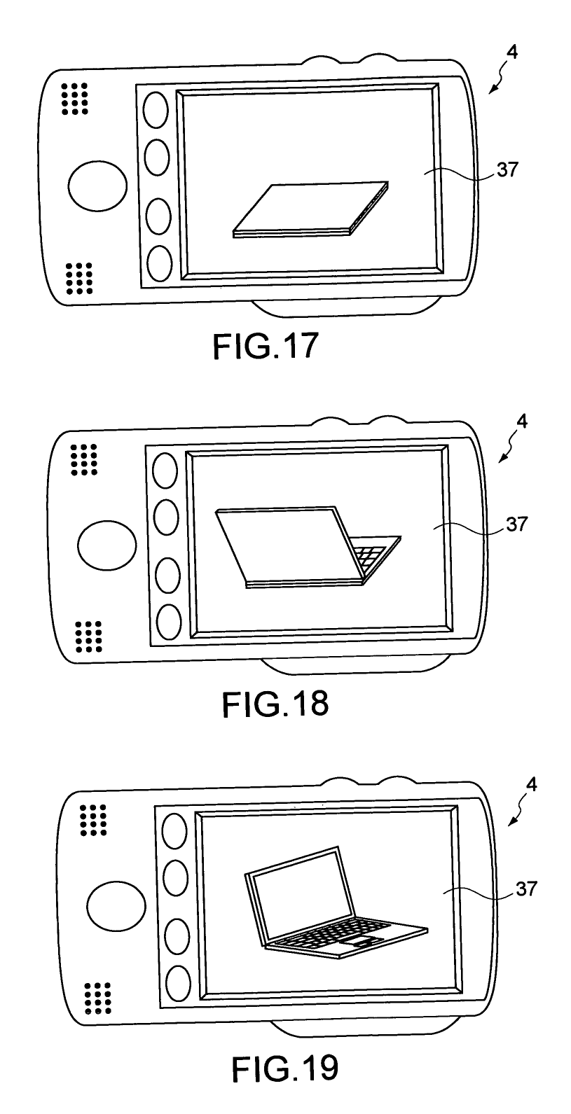

When, for instance, the number of outputs of the CM data is within a predetermined value, a first version of the CM data in which, for instance, a note type personal computer is in a closed state as shown in FIG. 17 may be displayed on the display 37, and when the CM data is outputted more than the predetermined number of times, CM data in which the note type personal computer is in an opened state, as shown in FIG. 18, may be displayed on the display 37. When the CM data are outputted exceeding another predetermined number of times, CM data in which a picture and a keyboard of the note type personal computer face front side may be displayed, as shown in FIG. 19, on the display 37. Thus, the version of the CM data to be presented may be changed in accordance with, for instance, the number of outputs. In this case, as shown in, for instance, the present embodiment, the CM data may be configured so that the entire picture of a targeted product is made gradually clearer every time the version is increased, such as to produce a story.

In the case of a version of the CM data being varied in accordance with the number of outputs as in the present embodiment, for instance, a counter that counts the number of outputs every time the CM data is outputted may be provided.

Furthermore, among the CM data, some CM data are more important and have to be presented prior to the other CM data (hereinafter, referred to as “important CM data”). Such important CM data may be made to present even when, for instance, a user switches to another channel without viewing the commercial messages.

Still furthermore, in the receiving terminal 4 according to the invention, when a capacity of the CM data memory 31 becomes full, the CM data can no longer be stored. Accordingly, when the capacity exceeds a definite value or becomes full, the stored data of the CM data memory 31 has to be erased.

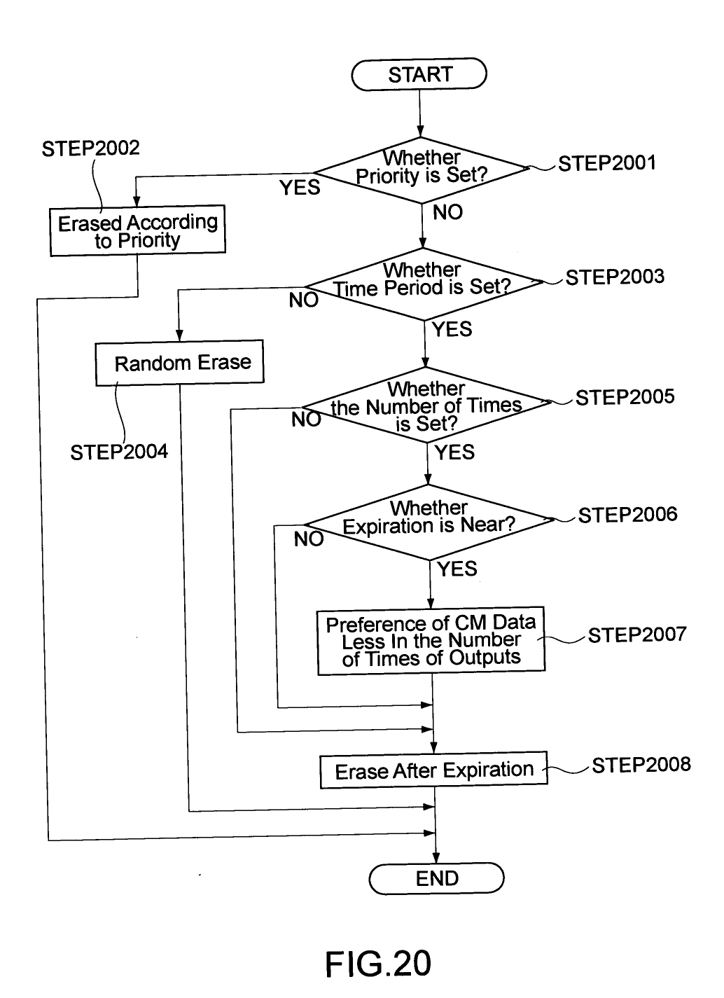

In that case, as shown in FIG. 20, by prioritizing the probability of being erased, for instance, a CM data that the sponsor thereof paid much for advertising is provided with a low probability of being erased, thus the CM data can be remained in the CM data memory 31 with higher probability (steps 2001 and 2002). Furthermore, irrespective of the memory capacity of the CM data memory 31, the CM data may be erased according to a predetermined time period set for each of the CM data lapse, (steps 2003 and 2004). Thereby, the memory capacity of the CM data memory 31 can be prevented from becoming full, and depending on an amount of advertising rate, the predetermined time period can be determined. In the case of the predetermined time period being thus set, in addition to setting of the time period, the number of times of presentations can be set (step 2005). Thereby, the CM data with its predetermined time period is about to lapse can be increased with the number of times to be outputted (steps 2006 and 2007).

The disclosure of Japanese Patent Application No. 2003-310345 filed Sep. 2, 2003 including Specification, Drawings and Claims are herein incorporated by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

1. A picture displaying apparatus, comprising:
a receiving means for receiving a broadcast wave;
a selecting means for selecting a channel to be displayed from the received broadcast wave;
a picture displaying means for displaying the picture of the selected channel;
a storing means for storing a commercial data for displaying a picture of a commercial message; and
a control means for controlling the picture displaying means so that the picture of the commercial message based on the stored commercial data is displayed prior to the picture of the channel selected by the channel selecting means.

2. A receiving apparatus, comprising:
a receiving means for receiving a broadcast wave;
a first selecting means for selecting a first channel to be displayed from the received broadcast wave; and
an outputting means for outputting a data related to a commercial message prior to outputting a data related to the broadcasted program of the first channel when the first channel is selected.

3. The receiving means as set forth in claim 2,
wherein when a data related to the broadcasted program of the first channel is switched to a second channel by the first selecting means, the outputting means outputs the data related to the commercial message prior to the data related to the broadcasted program of the second channel.

4. The receiving apparatus as set forth in claim 2,
wherein the first selecting means selects the first channel from the broadcast wave received by the receiving means when a power source of the receiving apparatus is turned on; and
wherein the outputting means outputs the data related to the commercial message prior to the data related to the broadcasted program of the first channel.

5. The receiving apparatus as set forth in claim 2, further comprising;
a display portion; and
wherein the outputting means outputs the data related to the commercial message in a first time period; the first time period being the time period beginning from the first channel is selected until the data related to the broadcasted program corresponding to the selected channel becomes capable of being displayed on the displaying portion.

6. The receiving apparatus as set forth in claim 5,
wherein the outputting means outputs the data related to the commercial message prior to outputting the data related to the broadcasted program when a second time period is longer than the first time period; the second time period being a time period which the data related to the commercial message is outputted.

7. The receiving apparatus as set forth in claim 5,
wherein the outputting means outputs the data related to the commercial message so that the picture displayed based on the data fades out to disappear when the second time period is longer than the first time period.

8. The receiving apparatus as set forth in claim 2, further comprising:
a first extracting means for extracting the data related to the commercial message contained in a controlling channel; the controlling channel being a channel contained in a broadcast wave for controlling the broadcast of the first channel and the second channel; and
a first storing means for storing the data related to the commercial message extracted by the first extracting means.

9. The receiving apparatus as set forth in claim 2, further comprising:
a second extracting means for extracting the data related to the commercial message contained in the data related to the broadcasted program; and
a second storing means for storing the data related to the commercial message extracted by the second extracting means.

10. The receiving apparatus as set forth in claim 2, further comprising:
a third storing means for storing a plurality of data related to the commercial message beforehand.

11. The receiving apparatus as set forth in claim 2, further comprising:
a position detecting means for receiving a GPS signal transmitted from a GPS satellite go around the earth and detecting a position of the receiving apparatus based on the received GPS signal; and
a second selecting means for selecting the data related to the commercial message according to the position detected by the position detecting means.

12. The receiving apparatus as set forth in claim 2,
wherein the outputting portion output a different version of the data related to the commercial message according to the number of times that the data related to the commercial message being outputted.

13. The receiving apparatus as set forth in claim 3,
wherein when a data related to the broadcasted program of the first channel is switched to the second channel by the first selecting means, the outputting means outputs data related to the commercial message which is to be broadcasted in the broadcasted program of the first channel prior to outputting the data related to the broadcasted program of the second channel.

14. The receiving apparatus as set forth in claim 8,
wherein each of the plurality of the data related to the commercial message stored in the storing means has a predetermined priority order; and
the receiving apparatus, further comprising:
an erasing means for erasing one of the plurality of data related to the commercial message stored in the storing means according to the priority order when the third storing means becomes full with data stored.

15. The apparatus as set forth in claim 8,
wherein each of the plurality of data related to the commercial message stored in the third storing means is designated with a date on which the data is to be erased; and
wherein the erasing means erases the data related to the commercial message according to the designated date.

16. The apparatus as set forth in claim 15,
wherein the data related to the commercial message is designated with the number of times that the commercial message is to be outputted; and
wherein the outputting means outputs the data related to the commercial message with the designated erasing day thereof is approaching and with the designated number of times to be outputted is small in a higher priority order.

17. A receiving apparatus, comprising:
a receiving means for receiving a broadcast wave;
a broadcasted program data outputting means for outputting the data related to the broadcasted program received through the broadcast wave; and
a commercial message data outputting means for outputting a data related to the commercial message when the data related to the broadcasted program is ceased to be outputted.

18. The receiving apparatus as set forth in claim 17,
wherein when a command to turn off a power source of the receiving apparatus is inputted, the commercial message data outputting means outputs the data related to the commercial message after the output of the data related to the broadcasted program is finished and prior to the turning off of the power source.

19. The receiving apparatus as set forth in claim 17,
wherein the commercial data outputting means outputs the data related to the commercial message when the data related to the broadcasted program is ceased to be outputted from the broadcasted program outputting means caused by the broadcast wave being ceased to be transmitted.

20. A method of presenting a commercial message, comprising the step of:
storing a data related to the commercial message transmitted through the broadcast wave beforehand in a receiving apparatus; and
outputting the data related to the commercial message prior to outputting a data related to the broadcasted program of a selected channel when the channel is selected in the receiving apparatus.

21. A method of presenting a commercial program, comprising the steps of:
transmitting broadcast wave containing a data related to the commercial message or storing the data related to the commercial message beforehand in a receiving apparatus for viewing a broadcasted program; and
outputting the data related to the commercial message when the receiving apparatus is incapable of outputting a data related to the broadcasted program of a channel selected in the receiving apparatus.
